(19) United States
(12) Patent Application Publication
(10) Pub. No.: US 2026/0296020 A1
(43) Pub. Date: Oct. 1, 2026

(54) Cleaning Device

(71) Applicant: SEIKO EPSON CORPORATION, Tokyo (JP)

(72) Inventor: Eiji OSAWA, Matsumoto (JP)

(21) Appl. No.: 19/577,508

(22) Filed: Mar. 25, 2026

(30) Foreign Application Priority Data
Mar. 26, 2025 (JP) 2025-050974

(51) Int. Cl. B41J 2/165; B06B 1/06

(52) U.S. Cl. CPC B41J 2/16505; B06B 1/0622; B41J 2/16579; B41P 2235/14

(57) ABSTRACT

A cleaning device for cleaning a nozzle plate having an injection surface and a plurality of nozzles for injecting a liquid formed therein, includes a cap disposed to face the injection surface, having a recess, and configured to store the liquid in a space surrounded by the recess and the injection surface, an ultrasonic device provided in the cap and transmitting ultrasonic waves toward the injection surface, and a controller, wherein the ultrasonic device includes first ultrasonic vibrators that transmit first ultrasonic waves as the ultrasonic waves having a first frequency, and second ultrasonic vibrators that transmit second ultrasonic waves as the ultrasonic waves having a second frequency lower than the first frequency, and the controller causes the ultrasonic device to transmit the first ultrasonic waves and then causes the ultrasonic device to transmit the second ultrasonic waves with the liquid stored in the space.

The present application is based on, and claims priority from JP Application Serial Number 2025-050974, filed Mar. 26, 2025, the disclosure of which is hereby incorporated by reference herein in its entirety.

### BACKGROUND

### 1. Technical Field

The present disclosure relates to a cleaning device.

### 2. Related Art

In the related art, there is a technique of removing deposits deposited on an injection nozzle that injects a liquid using ultrasonic waves (for example, JP-A-2006-347000). In the device of JP-A-2006-347000, an ultrasonic vibrator is provided in a cap that covers the injection nozzle, and ultrasonic waves are transmitted from the ultrasonic vibrator with a space between the injection nozzle and the ultrasonic vibrator filled with a liquid. As a result, the deposits are removed by the cavitation effect.

JP-A-2006-347000 is an example of the related art.

There is a demand for improvement in removal capability for removing deposits.

### SUMMARY

According to an aspect of the present disclosure, there is provided a cleaning device for cleaning a nozzle plate having an injection surface and a plurality of nozzles for injecting liquid formed therein. The cleaning device includes a cap that is disposed to face the injection surface, has a recess, and is configured to store the liquid in a space surrounded by the recess and the injection surface, an ultrasonic device that is provided in the cap and transmits ultrasonic waves toward the injection surface, and a controller, wherein the ultrasonic device includes a plurality of first ultrasonic vibrators that transmit first ultrasonic waves as the ultrasonic waves having a first frequency, and a plurality of second ultrasonic vibrators that transmit second ultrasonic waves as the ultrasonic waves having a second frequency lower than the first frequency, and the controller causes the ultrasonic device to transmit the first ultrasonic waves and then causes the ultrasonic device to transmit the second ultrasonic waves with the liquid stored in the space.

### BRIEF DESCRIPTION OF THE DRAWINGS

FIG. 1 is a schematic view showing a schematic configuration of a liquid injection apparatus.

FIG. 2 is an exploded perspective view of a liquid injection head.

FIG. 3 is a schematic cross-sectional view of a part of the liquid injection head and a cleaning device.

FIG. 4 shows an acoustic lens.

FIG. 5 is a plan view showing an overall configuration of an ultrasonic device.

FIG. 6 is a plan view showing a detailed configuration of the ultrasonic device.

FIG. 7 is a cross-sectional view taken along line VII-VII in FIG. 6.

FIG. 8 is a cross-sectional view taken along line VIII-VIII in FIG. 6.

FIG. 9 is a perspective view showing a relationship between channels and nozzles.

FIG. 10 is a waveform diagram of a burst signal.

FIG. 11 shows a relationship between the burst signals and ultrasonic waves.

FIG. 12 is a flowchart showing a procedure of cleaning processing.

FIG. 13 shows a cleaning method.

FIG. 14 is a plan view showing an overall configuration of an ultrasonic device according to a second embodiment.

FIG. 15 is a plan view showing an overall configuration of an ultrasonic device according to a third embodiment.

FIG. 16 is a plan view showing a detailed configuration of an ultrasonic device according to a fourth embodiment.

FIG. 17 is a cross-sectional view taken along line XVII-XVII in FIG. 16.

### DESCRIPTION OF EMBODIMENTS

### A. First Embodiment

### A1. Overall Configuration of Liquid Injection Apparatus

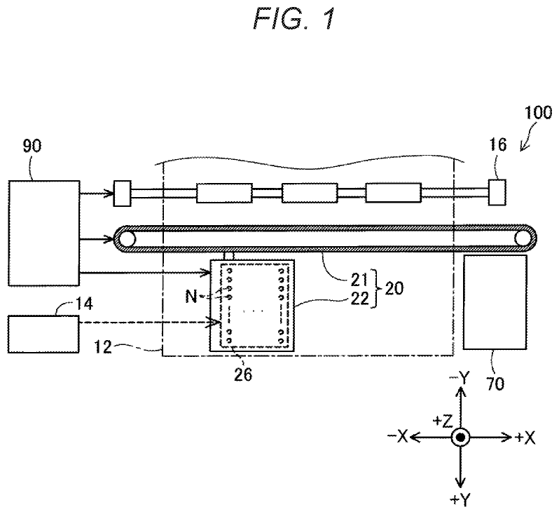

FIG. 1 is a schematic diagram showing a schematic configuration of a liquid injection apparatus 100 according to an embodiment. The liquid injection apparatus 100 is an inkjet printing apparatus that performs printing by injecting droplets of ink as a liquid onto a medium 12. As the medium 12, in addition to printing paper, a printing target of any material such as a resin film or cloth can be adopted. In the following description, an X direction, a Y direction, and a Z direction orthogonal to one another are used. For specification of the direction, positive and negative signs are used with the directions such that “+” is used with a positive direction and “−” is used with a negative direction. In the present embodiment, the X direction is a main scanning direction which is a movement direction of a liquid injection head 26. The Y direction is a sub-scanning direction that is a medium feeding direction orthogonal to the main scanning direction. The −Z direction is an injection direction of the ink. In the following description, the +Z direction may be referred to as “upper” and the −Z direction may be referred to as “lower”.

The liquid injection apparatus 100 includes the liquid injection head 26, a head moving mechanism 20, a liquid storage unit 14, a conveying mechanism 16, a cleaning device 70, and a controller 90.

The liquid storage unit 14 stores ink to be supplied to the liquid injection head 26. As the liquid storage unit 14, a bag-shaped liquid pack formed of a flexible film, an ink tank refillable with ink, a detachable ink cartridge, or the like can be used.

The liquid injection head 26 has a plurality of nozzles N for injecting ink. The plurality of nozzles N are arranged in the Y direction. The liquid injection head 26 injects the ink supplied from the liquid storage unit 14 from the plurality of nozzles N toward the medium 12.

The head moving mechanism 20 includes a conveying belt 21 and a carriage 22 that houses the liquid injection head 26. The carriage 22 is coupled to the conveying belt 21 and reciprocates in the X direction as the conveying belt 21 is driven. The conveying mechanism 16 conveys the medium 12 in the +Y direction.

The cleaning device 70 removes and cleans deposits DE deposited on the liquid injection head 26. The deposits DE are typically solidified color materials such as a pigment left after a solvent contained in the ink evaporates. When the deposits DE remain, the nozzle N is blocked by the deposits DE, which causes so-called clogging of ink, injection of ink deviated from a desired trajectory, and the like. Therefore, it is required to remove the deposits DE from the liquid injection head 26.

The controller 90 includes one or more processing circuits such as a central processing unit (CPU) or a field programmable gate array (FPGA) and a storage circuit such as a semiconductor memory, and controls the operation of the entire liquid injection apparatus 100. The controller 90 is electrically coupled to the conveying mechanism 16, the head moving mechanism 20, the liquid injection head 26, and the cleaning device 70, and controls each unit. The liquid is injected from the nozzles N onto the medium 12 being conveyed by the conveying mechanism 16, thereby printing an image on the medium 12.

### A2. Configuration of Liquid Injection Head:

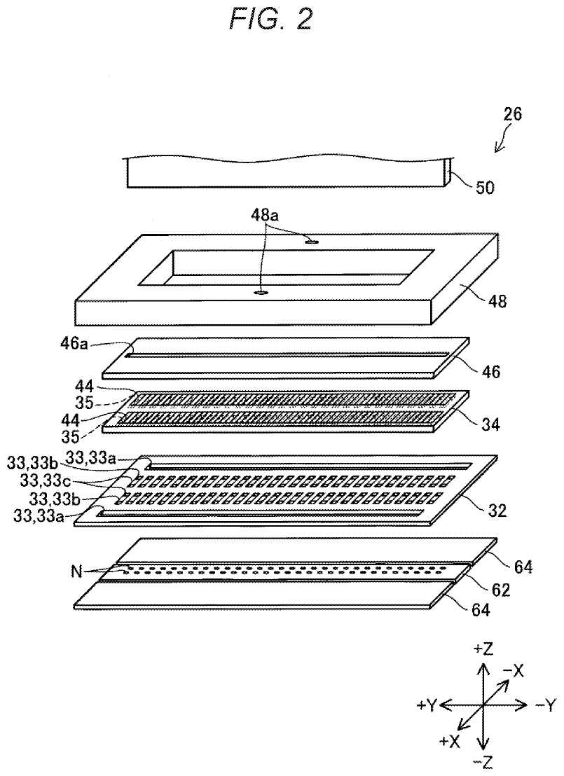

As illustrated in FIG. 2 which is an exploded perspective view of the liquid injection head 26 according to the embodiment, the liquid injection head 26 includes a nozzle plate 62, two vibration absorbers 64, a communication substrate 32, a pressure chamber substrate 34, a sealing body 46, a housing portion 48, and a circuit substrate 50. The nozzle plate 62, the vibration absorbers 64, the communication substrate 32, the pressure chamber substrate 34, and the sealing body 46 are plate-shaped members elongated in the Y direction. Each of the nozzle plate 62, the communication substrate 32, the pressure chamber substrate 34, and the sealing body 46 has a substantially line-symmetric structure with respect to a center line in the X direction. The size of the planar shape of the pressure chamber substrate 34 and the sealing body 46 is smaller than the size of the planar shape of the communication substrate 32 and the housing portion 48. In assembly, the nozzle plate 62 and the two vibration absorbers 64, the communication substrate 32, the pressure chamber substrate 34, the sealing body 46, and the housing portion 48 are stacked in this order and are bonded to each other by, for example, an adhesive.

The nozzle plate 62 is the plate-shaped member in which the plurality of nozzles N are formed. The nozzle N is a through hole having a substantially circular planar shape. The plurality of nozzles N are arranged along the Y direction. There are two rows side by side in the X direction, in which the plurality of nozzles N are arranged. The two vibration absorbers 64 are flexible films and are disposed with the nozzle plate 62 in between in the X direction.

The communication substrate 32 has communication portions 33. The communication portions 33 include two first openings 33a, a plurality of second openings 33b, and a plurality of third openings 33c. The planar shape of the first opening 33a is a quadrangle elongated in the Y direction. The first opening 33a is formed along a side of the communication substrate 32 parallel to the Y direction. The plurality of second openings 33b are arranged in the Y direction. Similarly, the plurality of third openings 33c are arranged in the Y direction. There are two rows of the second openings 33b and two rows of the third openings 33c. In the X direction, the first opening 33a, one row of second openings 33b, one row of third openings 33c, one row of third openings 33c, one row of second openings 33b, and the first opening 33a are formed side by side in this order. Further, the second opening 33b and the third opening 33c adjacent to each other in the X direction are formed such that the positions thereof in the Y direction are substantially the same.

A plurality of openings 35 are formed in a surface of the pressure chamber substrate 34 facing the communication substrate 32. The planar shape of the opening 35 is a quadrangle elongated in the X direction. The plurality of openings 35 are arranged in the Y direction. There are two rows in which the plurality of openings 35 are arranged, and the two rows are formed side by side in the X direction. The opening 35 is formed at a position overlapping the adjacent second opening 33b and third opening 33c formed in the communication substrate 32 when viewed from the Z direction.

Piezoelectric elements 44 are formed on a surface of the pressure chamber substrate 34 facing the sealing body 46. The sealing body 46 reinforces the strength of the pressure chamber substrate 34 and protects the piezoelectric elements 44. The sealing body 46 has a sealing body opening 46a and sealing body recesses. The planar shape of the sealing body opening 46a is a quadrangle elongated in the Y direction. The sealing body recesses are formed to be recessed from a surface of the sealing body 46 facing the piezoelectric element 44.

A drive circuit (not illustrated) for driving the piezoelectric elements 44 is mounted on the circuit board 50. Specifically, the drive circuit is implemented by an integrated circuit (IC) chip that outputs a reference voltage and a drive signal for driving the piezoelectric elements 44. The drive circuit and the piezoelectric elements 44 are electrically coupled via electric wiring (not illustrated).

The housing portion 48 is a case for storing ink and has a frame shape. When stacked, the pressure chamber substrate 34, a diaphragm 36, and the sealing body 46 are disposed in the internal space of the housing portion 48. Through holes 48a are formed at the respective ends of the housing portion 48 in the X direction.

### A3. Configuration of Cleaning Device:

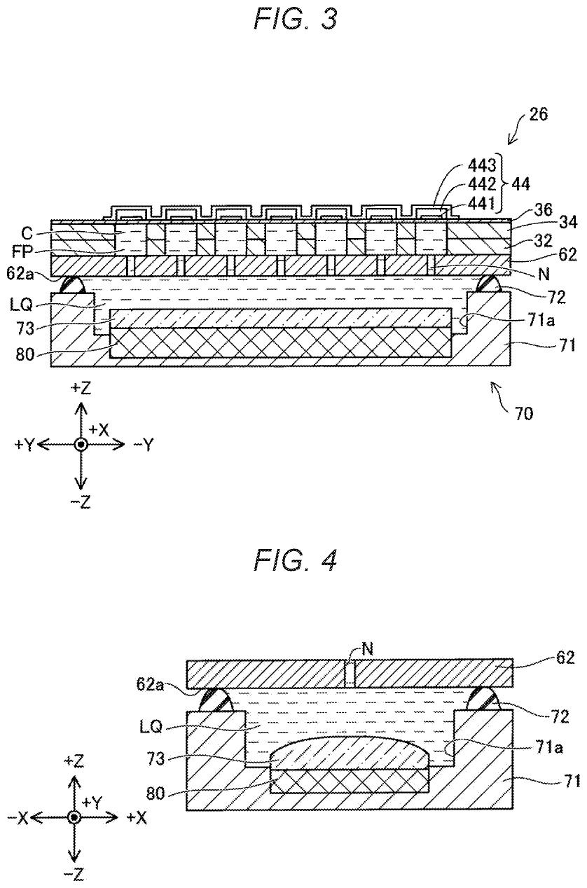

FIG. 3 is a schematic cross-sectional view of a part of the liquid injection head 26 and the cleaning device 70. FIG. 3 shows a state in which a cap 71 of the cleaning device 70 is attached to the liquid injection head 26 for cleaning processing. FIG. 3 is a cross-sectional view taken along a plane passing through the center of the nozzles N and being parallel to the YZ plane.

One cap 71 is provided for each nozzle row in which the plurality of nozzles N are arranged in the Y direction. In the following description, one cap 71 corresponding to one nozzle row of the two nozzle rows of the liquid injection head 26 will be described.

As shown in FIG. 3, the nozzles N are opened in an injection surface 62a which is one surface of the nozzle plate 62. The communication substrate 32, the pressure chamber substrate 34, and the diaphragm 36 are stacked on a surface of the nozzle plate 62 opposite to the injection surface 62a. Pressure chambers C and supply flow paths FP from the pressure chambers C to the nozzles N are formed by the pressure chamber substrate 34 and the communication substrate 32. The diaphragm 36 defines the pressure chambers C. Specifically, the pressure chambers C are defined by the sealing body recesses of the pressure chamber substrate 34, and the diaphragm 36 is a part of the pressure chamber substrate 34. The supply flow paths FP are defined by the communication portions 33 of the communication substrate 32. The piezoelectric elements 44 are formed on a surface of the diaphragm 36 opposite to the surface defining the pressure chamber C.

The piezoelectric element 44 includes a lower electrode 441, a piezoelectric layer 442, and an upper electrode 443. The lower electrode 441, the piezoelectric layer 442, and the upper electrode 443 are stacked in this order. The lower electrode 441 and the upper electrode 443 contain metals. The piezoelectric layer 442 contains, for example, lead zirconate titanate (PZT). In the present embodiment, in plan view in which the diaphragm 36 is viewed along the Z direction, the upper electrode 443 is not separated for each piezoelectric element 44, and is formed to cover the upper side of the plurality of nozzles N arranged in the Y direction. The lower electrode 441 is separated for each piezoelectric element 44. When a voltage is applied between the lower electrode 441 and the upper electrode 443, the piezoelectric layer 442 is deformed. The diaphragm 36 vibrates with the deformation of the piezoelectric layer 442.

The ink is supplied to the pressure chamber C from a flow path (not illustrated). When the pressure of the pressure chamber C is changed by the vibration of the diaphragm 36, the ink is injected from the nozzle N.

The cleaning device 70 includes the cap 71, an ultrasonic device 80, and the controller 90. The controller 90 controls not only the cleaning device 70 but also the entire liquid injection apparatus 100. For example, in the cleaning processing described later, the controller 90 controls the head moving mechanism 20, the cleaning device 70, and the like. Strictly speaking, the controller provided in the cleaning device 70 refers to a functional unit of the controller 90, which performs the cleaning processing described later, but in the description of the present application, the “controller 90” is used without detailed distinction. As described above, in the controller 90, the functional unit that performs the cleaning processing to be described later may be implemented by, for example, the CPU executing a program stored in the storage circuit, that is, by using software, may be implemented by using dedicated hardware such as an FPGA, or may be implemented by using both.

The cap 71 is configured to be movable between an attachment position shown in FIG. 3 where the cap 71 contacts the nozzle plate 62 and a release position where the cap 71 is separated from the nozzle plate 62 by a moving mechanism (not illustrated). When the cleaning processing is performed, the liquid injection head 26 moves to the placement position of the cap 71. When the liquid injection head 26 moves to the placement position of the cap 71, the cap 71 moves into contact with the nozzle plate 62.

The cap 71 is disposed to face the injection surface 62a. The cap 71 has a recess 71a. The cap 71 is configured to store a liquid LQ in a space surrounded by the recess 71a and the injection surface 62a. Examples of the material of the cap 71 include stainless steel and synthetic resin.

A packing 72 made of an elastic material is provided on the periphery of the cap 71. The material of the packing 72 is, for example, rubber. The packing 72 is provided, and thus leakage of the liquid LQ stored in the recess 71a can be suppressed. The cap 71 is provided with an ejection flow path (not illustrated) for ejection of the stored liquid LQ.

An acoustic lens 73 and the ultrasonic device 80 are disposed to be superimposed on the bottom surface facing the injection surface 62a among the surfaces defining the recess 71a of the cap 71.

FIG. 4 shows the acoustic lens 73. FIG. 4 is a cross-sectional view taken along a plane passing through the center of the nozzle N and being parallel to the XZ plane. The acoustic lens 73 focuses ultrasonic waves in a lens focusing range (not illustrated) on the injection surface 62a. The lens focusing range is set in advance to include the plurality of nozzles N. The lens focusing range has a predetermined length in the X direction as a second direction. Specifically, as illustrated in FIG. 4, among the surfaces of the acoustic lens 73, the surface facing the nozzle N is a curved surface convex toward the nozzle N. The acoustic lens 73 is fabricated so as to form a propagation path of ultrasonic waves such that the ultrasonic waves transmitted from the ultrasonic device 80 are focused in the lens focusing range when the ultrasonic waves transmitted from the ultrasonic device 80 enter the acoustic lens 73.

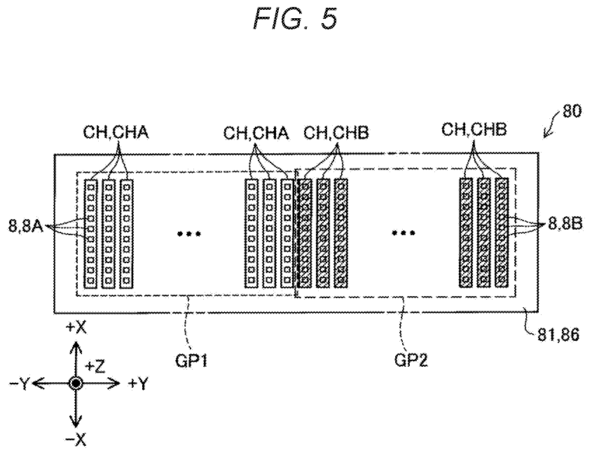

FIG. 5 is a plan view showing an overall configuration of the ultrasonic device 80. As shown in FIG. 5, the ultrasonic device 80 has a plurality of ultrasonic vibrators 8. The plurality of ultrasonic vibrators 8 include a plurality of first ultrasonic vibrators 8A and a plurality of second ultrasonic vibrators 8B. The first ultrasonic vibrator 8A transmits first ultrasonic waves as ultrasonic waves having a first frequency. The second ultrasonic vibrator 8B transmits second ultrasonic waves as ultrasonic waves having a second frequency. The frequency of the second ultrasonic waves is lower than the frequency of the first ultrasonic waves. In the present embodiment, the frequency of the first ultrasonic waves is from about 1 MHz to about 10 MHz. The frequency of the second ultrasonic waves is about 100 kHz or more and less than 1 MHz.

The ultrasonic vibrators 8 are formed on a first substrate 81 described later. In the present embodiment, the ultrasonic vibrators 8 are arranged in a matrix. The plurality of ultrasonic vibrators 8 are divided into a first group GP1 including the plurality of first ultrasonic vibrators 8A and a second group GP2 including the plurality of second ultrasonic vibrators 8B. The first group GP1 and the second group GP2 are adjacent to each other in the Y direction.

As will be described later, one channel CH includes the plurality of ultrasonic vibrators 8 arranged in the X direction. The channel CH including the first ultrasonic vibrators 8A is also referred to as a first channel CHA. The channel CH including the second ultrasonic vibrators 8B is also referred to as a second channel CHB.

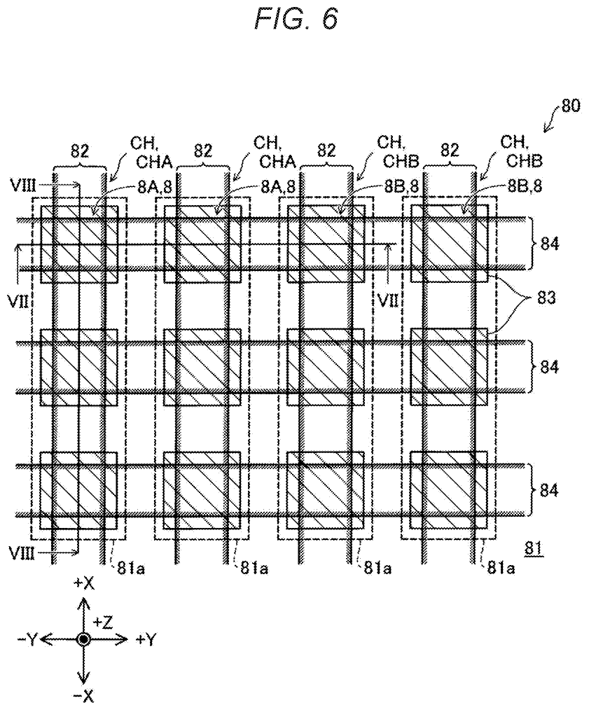

FIG. 6 is a plan view showing a detailed configuration of the ultrasonic device 80. The ultrasonic device 80 includes the first substrate 81, a plurality of first electrodes 82, a plurality of piezoelectric elements 83, and a plurality of second electrodes 84. The first electrodes 82, the piezoelectric elements 83, and the second electrodes 84 are sequentially stacked on the first substrate 81. The first electrode 82 and the second electrode 84 contain metals. The piezoelectric element 83 contains, for example, lead zirconate titanate.

In the present embodiment, the shape of each first electrode 82 in plan view viewed along the Z direction is a rectangle elongated in the X direction. The shape of each second electrode 84 in plan view is a rectangle elongated in the Y direction. The respective first electrodes 82 and second electrodes 84 are routed to ends of the first substrate 81. The respective first electrodes 82 and second electrodes 84 are electrically coupled to terminals formed at the ends of the first substrate 81 for electrical coupling to a drive circuit for the ultrasonic device 80 provided in the controller 90.

Although not illustrated in FIG. 6, in the present embodiment, the plurality of second electrodes 84 are electrically coupled to one another at the ends of the first substrate 81. When the ultrasonic device 80 is controlled, a common voltage is applied to the plurality of second electrodes 84. In contrast, individual voltages independent of one another are applied to the plurality of first electrodes 82. Therefore, the first electrode 82 is also referred to as an individual electrode, and the second electrode 84 is also referred to as a common electrode. The piezoelectric element 83 is formed in a range in which the first electrode 82 and the second electrode 84 overlap. A portion in which the first electrode 82, the piezoelectric element 83, and the second electrode 84 overlap is referred to as an ultrasonic vibrator 8. The piezoelectric element 83 corresponding to the first ultrasonic vibrator 8A is also referred to as a first piezoelectric element, and the piezoelectric element 83 corresponding to the second ultrasonic vibrator 8B is also referred to as a second piezoelectric element.

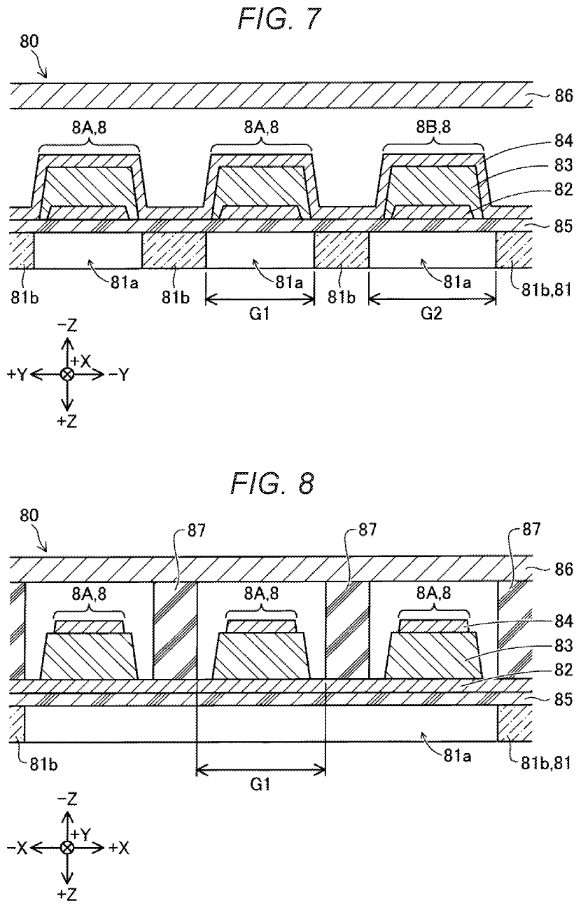

FIG. 7 is a cross-sectional view taken along line VII-VII in FIG. 6. FIG. 8 is a cross-sectional view taken along line VIII-VIII in FIG. 6. As shown in FIG. 8, the ultrasonic device 80 includes a diaphragm 85, a second substrate 86, and a plurality of column portions 87 in addition to the configuration described above. Opening portions 81a are formed in the first substrate 81. The diaphragm 85 is disposed between the first substrate 81 and the first electrodes 82. The second substrate 86 is disposed above the ultrasonic vibrators 8 so as to cover the ultrasonic vibrators 8.

In the present embodiment, the first substrate 81 is a silicon substrate. In the present embodiment, the diaphragm 85 is a laminated film of a silicon oxide film and a zirconium oxide film. In the present embodiment, as shown in FIG. 6, in plan view in which the diaphragm 85 is viewed in the Z direction, in the first substrate 81, the opening portions 81a are formed so as to include one ultrasonic vibrator 8 with respect to the Y direction and include three ultrasonic vibrators 8 with respect to the X direction.

As illustrated in FIGS. 7 and 8, the opening portions 81a are defined by wall portions 81b. As shown in FIG. 7, the wall portions 81b are formed between two ultrasonic vibrators 8 adjacent to each other in the Y direction. As illustrated in FIG. 8, the wall portions 81b are formed between the three ultrasonic vibrators 8 arranged in the X direction and the three ultrasonic vibrators 8 adjacent thereto.

In the present embodiment, as shown in FIG. 8, the column portions 87 are formed between the two ultrasonic vibrators 8 adjacent to each other in the X direction. The column portions 87 are bonded to the diaphragm 85 and the second substrate 86. In the present embodiment, the column portion 87 is formed of a so-called permanent resist which is a photosensitive resin remaining as a structure without being removed after development. The second substrate 86 functions as a sealing substrate. A bonding portion (not illustrated) protruding toward the first substrate 81 is formed in an outer edge of the second substrate 86. The second substrate 86 is bonded to the first substrate 81 by bonding the bonding portion to the first substrate 81.

When a voltage is applied between the first electrode 82 and the second electrode 84, the piezoelectric element 83 is deformed, the diaphragm 85 vibrates, and ultrasonic waves are transmitted. The vibration of the diaphragm 85 is suppressed by the wall portions 81b and the column portions 87. The wall portions 81b and the column portions 87 function as fixed ends of vibration.

As illustrated in FIG. 7, a first gap G1 which is a distance between the two wall portions 81b adjacent to each other in the Y direction with the first ultrasonic vibrator 8A in between is smaller than a second gap G2 which is a distance between the two wall portions 81b adjacent to each other in the Y direction with the second ultrasonic vibrator 8B in between. As described above, the two adjacent wall portions 81b function as fixed ends of vibration. Therefore, the resonance frequency of the ultrasonic vibrator 8 changes according to the distance between the two wall portions 81b. In the present embodiment, the first gap G1 is smaller than the second gap G2 so that the resonance frequency of the first ultrasonic vibrator 8A is higher than the resonance frequency of the second ultrasonic vibrator 8B. Accordingly, the first ultrasonic vibrator 8A can transmit ultrasonic waves having a frequency higher than the frequency of the ultrasonic waves transmitted from the second ultrasonic vibrator 8B.

Although the second gap G2 is not illustrated in FIG. 8, the first gap G1 as the distance between the two column portions 87 adjacent to each other in the X direction with the first ultrasonic vibrator 8A in between is smaller than the second gap G2 as the distance between the two column portions 87 adjacent to each other in the Y direction with the second ultrasonic vibrator 8B in between.

The two wall portions 81b adjacent to each other in the Y direction are also referred to as a pair of fixing portions. The two column portions 87 adjacent to each other in the X direction are also referred to as a pair of fixing portions. The pair of fixing portions functions as fixed ends of vibration by fixing the diaphragm 85 that vibrates according to the vibration of the corresponding piezoelectric element 83 to the first substrate 81 or the second substrate 86 as the substrate facing the diaphragm 85.

As described above, in the present embodiment, the first electrode 82 is the individual electrode, and the second electrode 84 is the common electrode. As shown in FIG. 6, among the plurality of ultrasonic vibrators 8, a group of ultrasonic vibrators 8 sharing the same first electrode 82 is referred to as the “channel CH”.

In FIGS. 7 and 8, the ultrasonic device 80 is illustrated in an arrangement mode in which the distance between the first substrate 81 and the acoustic lens 73 is shorter than the distance between the second substrate 86 and the acoustic lens 73, but the arrangement mode of the ultrasonic device 80 is not limited thereto. The ultrasonic device 80 may be disposed on the cap 71 in an arrangement mode in which the distance between the second substrate 86 and the acoustic lens 73 is shorter than the distance between the first substrate 81 and the acoustic lens 73, that is, in an arrangement mode vertically inverted from FIGS. 7 and 8.

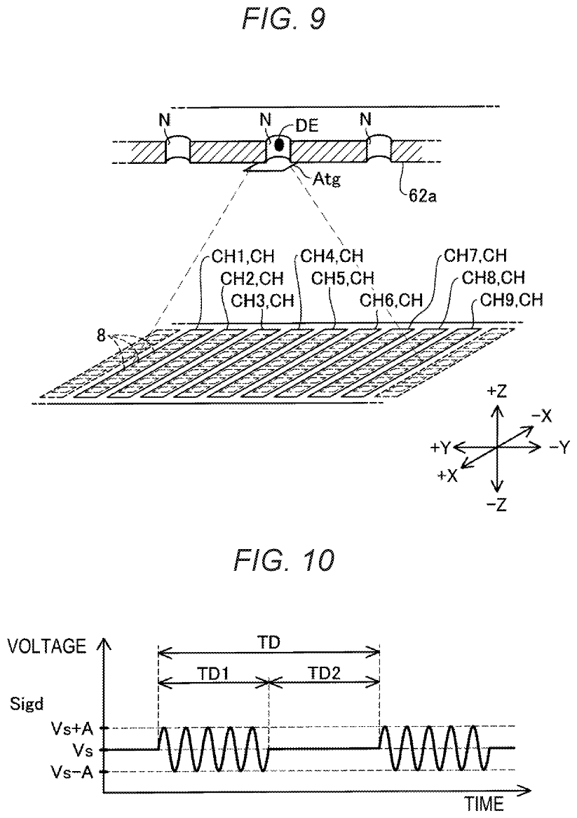

FIG. 9 is a perspective view showing a relationship between the channels CH and the nozzles N. As shown in FIG. 9, the plurality of channels CH are arranged in the Y direction as a first direction. The arrangement direction of the plurality of channels CH coincides with the arrangement direction of the nozzles N. Accordingly, by shifting the emission timings of ultrasonic burst waves transmitted from the plurality of channels CH from one another, the ultrasonic waves can be focused on the target nozzle N among the plurality of nozzles N.

FIG. 10 is a waveform diagram of a burst signal Sigd applied to the individual electrode. As illustrated in FIG. 10, the burst signal Sigd is a burst signal in which a first period TD1 in which a sine wave is transmitted and a second period TD2 in which a DC voltage is transmitted are repeated in a cycle TD. The sine wave in the first period TD1 is a sine wave having amplitude A at the center voltage of the amplitude as a reference voltage Vs. The voltage in the second period TD2 is the reference voltage Vs. The first period TD1 is also referred to as a signal transmission period.

The controller 90 inputs the burst signal Sigd to the ultrasonic vibrator 8 to control the ultrasonic device 80. When the reference voltage Vs is applied to the second electrode 84 of the ultrasonic vibrator 8 and the burst signal Sigd is input to the first electrode 82 of the ultrasonic vibrator 8, the ultrasonic vibrator 8 transmits ultrasonic burst waves. The ultrasonic burst waves are ultrasonic waves for which an ultrasonic wave transmission period in which the ultrasonic waves are transmitted and a period in which the emission of the ultrasonic waves is stopped are repeated in a cycle TD.

The controller 90 inputs the burst signal Sigd in which the frequency of the waveform in the first period TD1 is the first frequency to the first ultrasonic vibrator 8A. Accordingly, when the burst signal Sigd is input, the first ultrasonic vibrator 8A transmits burst waves in which the frequency in the ultrasonic wave transmission period is the first frequency. The controller 90 inputs the burst signal Sign in which the frequency of the waveform in the first period TD1 is the second frequency to the second ultrasonic vibrator 8B. Accordingly, when the burst signal Sigd is input, the second ultrasonic vibrator 8B transmits burst waves in which the frequency in the ultrasonic wave transmission period is the second frequency.

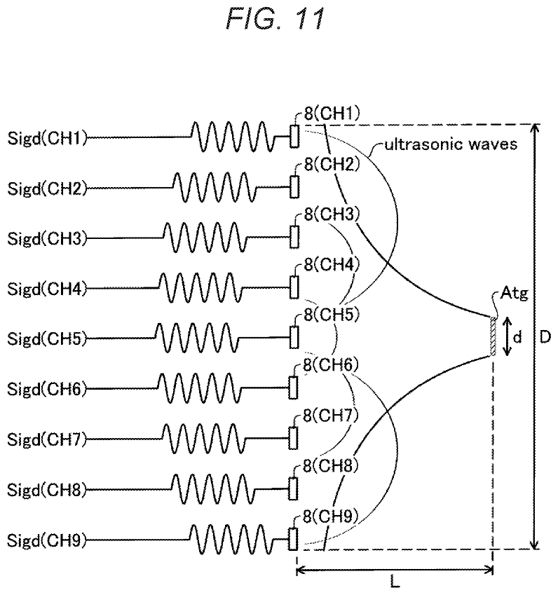

FIG. 11 shows a relationship between the burst signals Sigd input to the plurality of channels CH and the ultrasonic waves transmitted from the plurality of channels CH. FIG. 11 illustrates a case where a target range Atg in which ultrasonic waves are to be focused is on a fifth channel CH5 as an example. In the following description, for ease of understanding, a case where nine channels CH from the first channel CH1 to the ninth channel CH9 are controlled in order to focus the ultrasonic waves in the target range Atg will be described as an example.

The controller 90 performs control such that the emission timing at which the ultrasonic vibrator 8 transmits ultrasonic waves is shifted according to the distance between the target range Atg and the ultrasonic vibrator 8. The distance between the target range Atg and the ultrasonic vibrator 8 is the distance between the center of the target range Atg and the center of the ultrasonic vibrator 8.

As illustrated in FIG. 11, the controller 90 controls the plurality of ultrasonic vibrators 8 such that the emission timing of the burst waves transmitted from the fifth channel CH5 among the plurality of channels CH is the latest and the emission timing of the burst waves is shifted according to the arrangement direction of the plurality of channels CH. Specifically, the controller 90 sets the start time of the first period TD1 of each burst signal Sigd to be later in the order of the first channel CH1, the second channel CH2, the third channel CH3, the fourth channel CH4, and the fifth channel CH5, and to be earlier in the order of the fifth channel CH5, the sixth channel CH6, the seventh channel CH7, the eighth channel CH8, and the ninth channel CH9. As a result, the ultrasonic waves transmitted from the channels CH are superimposed in the target range Atg and become ultrasonic waves having larger amplitude. As described above, the controller 90 focuses the ultrasonic waves in the target range Atg by performing control such that the emission timing at which each of the plurality of ultrasonic vibrators 8 transmits the burst waves is shifted according to the first direction.

In general, when the diameter of the range in which the ultrasonic waves are transmitted is D [m], the diameter of the range in which the ultrasonic waves are focused is d [m], the distance from the range in which the ultrasonic waves are transmitted to the range in which the ultrasonic waves are focused is L [m], and the frequency of the ultrasonic waves is f [Hz], the beam diameter d is expressed by the following Expression (1). In Expression (1), “c” is the sound velocity [m/s].

d=(1.02×L×c)/(D×f) (1)

As shown in Expression (1), the beam diameter d can be reduced as the frequency of the ultrasonic wave is increased. In the present embodiment, the beam diameter d can be made smaller by setting the first frequency to 1 MHz or more. In the present embodiment, the diameter of the nozzle N is about 20 μm.

### A4. Cleaning Processing:

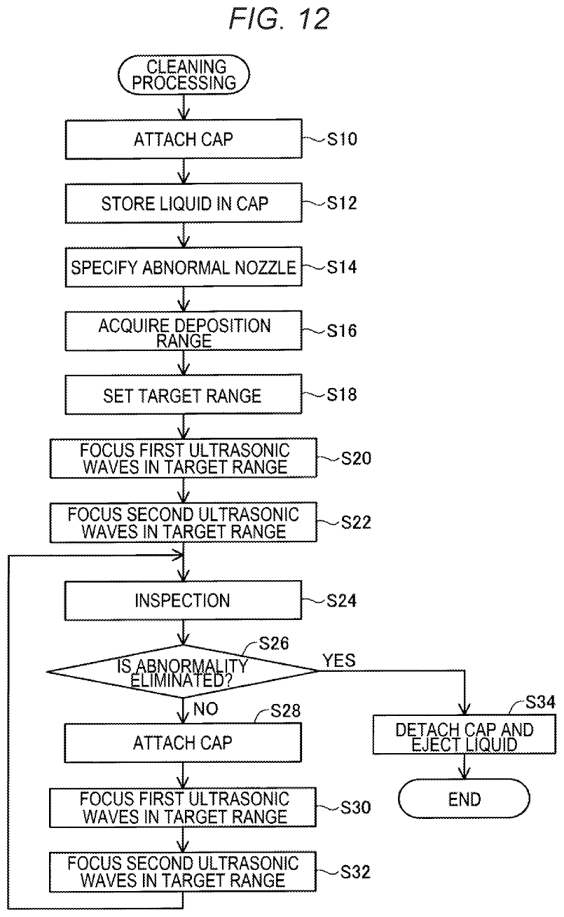

FIG. 12 is a flowchart showing a procedure of the cleaning processing. A user who uses the liquid injection apparatus 100 instructs the liquid injection apparatus 100 to perform cleaning via an interface (not illustrated), for example, when the user views a printed matter and the printing quality is not good. Upon receiving the cleaning instruction, the controller 90 performs the cleaning processing.

In step S10 of FIG. 12, the controller 90 moves the liquid injection head 26 to the position of the cleaning device 70 and moves the cap 71 so that the cap 71 comes into close contact with the injection surface 62a, thereby attaching the cap 71 to the liquid injection head 26.

In step S12, the controller 90 stores the liquid LQ in the recess 71a of the cap 71. In the present embodiment, the controller 90 causes the liquid injection head 26 to inject ink to fill a space surrounded by the injection surface 62a and the recess 71a with ink. As another embodiment, the liquid LQ stored in the cap 71 may be pure water or a cleaning liquid instead of the printing ink.

In step S14, the controller 90 specifies an abnormal nozzle having an injection abnormality in which normal injection is not performed among the plurality of nozzles N. The cases in which normal injection is not performed include a case in which injection of a predetermined amount of ink designated by the controller 90 is not performed, a case in which ink is not injected at a desired speed, and a case in which injected ink does not fly in a desired flight path and ink is landed at a position deviated from a desired landing position on the medium 12.

In the present embodiment, the controller 90 detects a residual vibration when the ink is injected in step S12, and specifies the abnormal nozzle by comparing the detected residual vibration with a predetermined reference vibration. The residual vibration is a vibration of the piezoelectric element 44 after a drive voltage for injection is applied to the piezoelectric element 44 of the liquid injection head 26.

Specifically, a detection wire for detecting the residual vibration is electrically coupled to the upper electrode 443 separately from a drive wire for applying the drive voltage. The residual vibration is converted into a voltage by the piezoelectric layer 442. Therefore, the controller 90 detects the residual vibration by detecting the fluctuations of the voltage of the detection wire after the drive voltage is applied.

The residual vibration varies depending on the volume of the pressure chamber C, the weight of the ink, and the like. Therefore, when the deposits DE are deposited inside of the nozzle N or the periphery of the nozzle N on the injection surface 62a, for example, the cycle of the residual vibration shifts from the cycle of the reference vibration. In the present embodiment, the controller 90 determines that the target nozzle N is abnormal when the cycle of the residual vibration of the target nozzle N is outside a predetermined reference cycle range.

In step S16, the controller 90 acquires the abnormal nozzle specified in step S14 as the deposition range in which the deposits DE are deposited. In step S18, the controller 90 sets the target range Atg using the deposition range. Specifically, the controller 90 sets a range including at least one of the abnormal nozzle and the nozzle periphery which is a range on the injection surface 62a surrounding the abnormal nozzle as the target range Atg. As shown in FIG. 9, when the range including the nozzle N is set as the target range Atg, the range including the nozzle N on the same plane as the injection surface 62a is set as the target range Atg in the plan view in which the nozzle plate 62 is viewed from the direction perpendicular to the nozzle plate 62.

For ease of understanding, the target range Atg illustrated in FIG. 9 indicates a range after the ultrasonic waves transmitted by the ultrasonic vibrator 8 are further focused by the acoustic lens 73. In the present embodiment, if the acoustic lens 73 is not provided, the ultrasonic waves transmitted from the ultrasonic device 80 are not focused with respect to the X direction. Therefore, specifically, in step S18, the controller 90 sets the position range in the Y direction on the injection surface 62a as the target range Atg.

In step S20 of FIG. 12, the controller 90 causes the first ultrasonic vibrator 8A provided in the first channel CHA to transmit the first ultrasonic waves so that the first ultrasonic waves are focused in the target range Atg. Specifically, the controller 90 inputs the burst signal Sigd to the first ultrasonic vibrator 8A and causes the ultrasonic vibrator 8A to transmit burst waves. As described above, the burst signal Sigd input to the first ultrasonic vibrator 8A of each of the first channel CH1 to the ninth channel CH9 is adjusted such that the emission time of the burst waves is shifted according to the first direction. The ultrasonic waves transmitted from the ultrasonic device 80 propagate through the acoustic lens 73, then propagate through the liquid LQ stored in the cap 71, and are focused in the target range Atg. Accordingly, a large number of fine bubbles are generated near the target range Atg.

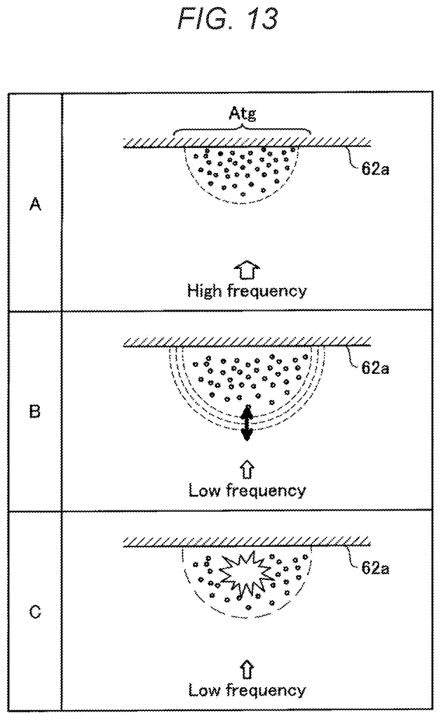

FIG. 13 shows a method of removing the deposits DE in the present application. In the method of the present application, after the ultrasonic waves having the first frequency are transmitted in step S20, the ultrasonic waves having the second frequency lower than the first frequency are transmitted in step S22.

In general, the higher the frequency of the transmitted ultrasonic waves, the smaller the diameter of the bubble generated by cavitation. Therefore, as indicated by “A” in FIG. 13, when the first ultrasonic waves having the high frequency are focused in the target range Atg, a large number of fine bubbles are generated near the target range Atg due to cavitation. Such a large number of bubbles are generated substantially in a semi-ellipsoidal range, and are also called a cloud.

Then, as indicated by “B” in FIG. 13, when the second ultrasonic waves having a low frequency are transmitted to the target range Atg, the large number of bubbles are forcibly vibrated. Then, as indicated by “C” in FIG. 13, the large number of bubbles eventually collapse, and a shock wave is generated.

It is considered that when low-frequency ultrasonic waves are transmitted to the cloud, the volume of the bubbles decreases, and in particular, a large number of bubbles collapse near the center of the cloud and a very high pressure is applied to the surroundings. As described above, the second ultrasonic wave having a low frequency are transmitted after the first ultrasonic waves having a high frequency are transmitted, and thus it is possible to generate high pressure by shock wave in the target range Atg.

In step S22 of FIG. 12, the controller 90 causes the second ultrasonic vibrator 8B provided in the second channel CHB to transmit the second ultrasonic waves so that the second ultrasonic waves focus in the target range Atg within a predetermined time from the end of the emission of the first ultrasonic waves. Specifically, the controller 90 inputs the burst signal Sigd to the second ultrasonic vibrator 8B and causes the second ultrasonic vibrator 8B to transmit burst waves. As a result, as described above, a large number of bubbles collapse to generate shock wave. The deposits DE are removed from the nozzle plate 62 by high pressure by the shock wave or an acoustic radiation force of the ultrasonic waves. The predetermined time from the end of the emission of the first ultrasonic waves to the start of the emission of the second ultrasonic waves is, for example, about 1 to 100 microseconds.

Unlike the present embodiment, when continuous waves are transmitted from the ultrasonic device 80, standing waves of ultrasonic waves are generated in the liquid LQ between the ultrasonic device 80 and the injection surface 62a. The sound pressure at the antinode of the standing waves is high, but the sound pressure at the node of the standing waves is low. Therefore, a portion where cavitation is likely to occur and a portion where cavitation is unlikely to occur are generated in the entire liquid LQ, and cleaning unevenness is likely to occur. In this regard, according to the present embodiment, since the ultrasonic waves are selectively focused in the target range Atg, a large number of fine bubbles are generated near the target range Atg and the second ultrasonic waves are transmitted to collapse the large number of fine bubbles to generate the shock wave, so that the portion on which the deposits DE are deposited can be efficiently cleaned.

In the present embodiment, the plurality of first ultrasonic vibrators 8A are densely arranged in the Y direction. Accordingly, the sound pressure of the first ultrasonic waves transmitted to the target range Atg can be increased as compared with a case where the plurality of first ultrasonic vibrators 8A are sparsely arranged.

In step S22 of the present embodiment, the second ultrasonic waves are focused in the target range Atg. As another embodiment, the second ultrasonic waves may not be focused in the target range Atg. Specifically, in step S22, for example, the controller 90 may perform control such that ultrasonic waves are simultaneously transmitted from all the second ultrasonic vibrators 8B.

In step S24, the controller 90 inspects whether the injection abnormality of the abnormal nozzle is eliminated. In the present embodiment, after temporarily moving the cap 71 to the release position, the controller 90 performs the inspection using the residual vibration when the ink is injected from the nozzle N, similarly to step S14.

In step S26, the controller 90 determines whether the injection abnormality of the abnormal nozzle is eliminated. When determining that the injection abnormality of the abnormal nozzle is not eliminated in step S26, the controller 90 moves the cap 71 to the attachment position in step S28. In step S30, the controller 90 causes the ultrasonic device 80 to transmit first ultrasonic waves so that the first ultrasonic waves are focused in the target range Atg, similarly to step S20. In step S28, after the cap 71 is attached, processing of filling the space surrounded by the injection surface 62a and the recess 71a with ink may be performed by injecting ink from the liquid injection head 26.

In step S32, the controller 90 causes the ultrasonic device 80 to transmit second ultrasonic waves so that the ultrasonic waves are focused in the target range Atg, similarly to step S22.

After performing step S32, the controller 90 returns the processing step to step S24 in order to confirm whether the injection abnormality of the abnormal nozzle is eliminated. When determining that the injection abnormality of the abnormal nozzle is eliminated in step S26, the controller 90 moves the cap 71 to the release position and detaches the cap, ejects the liquid LQ stored in the recess 71a of the cap 71 using a liquid ejection flow path (not illustrated) in step S34, and ends the processing routine.

According to the first embodiment described above, the cleaning device 70 includes the cap 71, the ultrasonic device 80, and the controller 90. The ultrasonic device 80 includes the plurality of first ultrasonic vibrators 8A that transmit first ultrasonic waves and the plurality of second ultrasonic vibrators 8B that transmit second ultrasonic waves having the second frequency lower than the first frequency. After causing the ultrasonic device 80 to transmit the first ultrasonic waves in step S20, the controller 90 causes the ultrasonic device 80 to transmit the second ultrasonic waves in step S22. Due to the cavitation generated by the emission of the first ultrasonic waves, a large number of fine bubbles are generated in the liquid LQ near the target range Atg. Thereafter, the second ultrasonic waves are transmitted, so that a large number of bubbles collapse, shock wave is generated, and high pressure is instantaneously generated. As described above, since high pressure can be efficiently generated, it is possible to improve the removal capability for the deposits DE deposited on the injection surface 62a. The cleaning efficiency can be improved as compared with a case where ultrasonic waves having a single frequency are transmitted.

In step S16, the controller 90 sets a range including the abnormal nozzle, which is a part of the range including the injection surface 62a and the plurality of nozzles N, as the target range Atg. Then, in step S20, the controller 90 controls the ultrasonic device 80 to focus the first ultrasonic waves in the target range Atg. Accordingly, a large number of fine bubbles can be generated selectively near the target range Atg. Thus, the deposits DE can be efficiently removed.

Furthermore, the cleaning device 70 includes the diaphragm 85, the plurality of piezoelectric elements 83, and the first substrate 81 disposed to face the diaphragm 85. The first gap G1 between the pair of wall portions 81b corresponding to the first ultrasonic vibrator 8A is formed to be smaller than the second gap G2 between the pair of wall portions 81b corresponding to the second ultrasonic vibrator 8B. The first gap G1 between the pair of column portions 87 corresponding to the first ultrasonic vibrator 8A is formed to be smaller than the second gap G2 between the pair of column portions 87 corresponding to the second ultrasonic vibrator 8B. Accordingly, the resonance frequency of the first ultrasonic vibrator 8A is set to be higher than the resonance frequency of the second ultrasonic vibrator 8B. As described above, the patterns of the wall portions 81b and the column portions 87 are changed, and thus the first ultrasonic vibrators 8A and the second ultrasonic vibrators 8B that transmit ultrasonic waves having different frequencies can be easily fabricated on the same first substrate 81.

### B. Second Embodiment

An ultrasonic device 80 of a second embodiment is different from the ultrasonic device 80 of the first embodiment in the arrangement mode of the first ultrasonic vibrators 8A and the second ultrasonic vibrators 8B. The differences from the first embodiment will be described, and the other description will be omitted. The same configurations and processing steps as those of the first embodiment are denoted by the same signs, and the detailed description thereof will be omitted as appropriate.

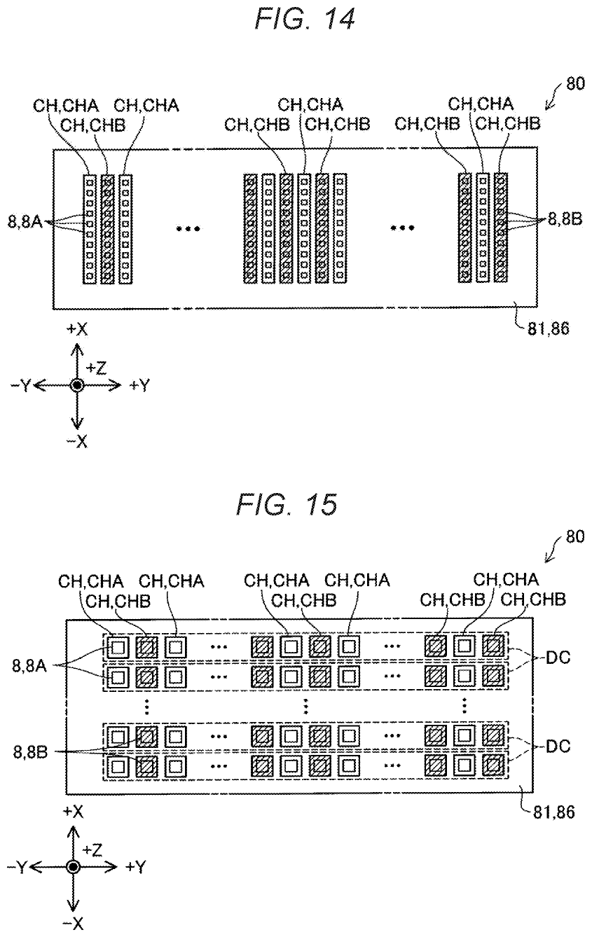

FIG. 14 is a plan view showing an overall configuration of the ultrasonic device 80 of the present embodiment. Also in the present embodiment, a first channel CHA in which a plurality of first ultrasonic vibrators 8A are arranged in the X direction and a second channel CHB in which a plurality of second ultrasonic vibrators 8B are arranged in the X direction are formed.

In the present embodiment, the first channels CHA and the second channels CHB are alternately arranged in the Y direction. Accordingly, first ultrasonic waves having higher sound pressure can be focused in the target range Atg over the entire region of the plurality of nozzles N. In the ultrasonic device 80 of the first embodiment, the first ultrasonic vibrators 8A are densely arranged in the Y direction. Therefore, the sound pressure of the ultrasonic waves transmitted to the nozzle plate 62 portion above the first ultrasonic vibrators 8A of the first embodiment can be increased. In contrast, the sound pressure of the first ultrasonic waves transmitted to the portion of the nozzle plate 62 away from the first ultrasonic vibrators 8A is lower than the sound pressure of the ultrasonic waves transmitted to the nozzle plate 62 portion above the first ultrasonic vibrators 8A. In this regard, in the ultrasonic device 80 of the present embodiment, the first channels CHA are arranged over the entire region of the nozzle plate 62 in plan view. Accordingly, the longest distance between the first ultrasonic vibrators 8A and the nozzles N can be made shorter than the longest distance between the first ultrasonic vibrators 8A and the nozzles N of the first embodiment. Therefore, it is possible to transmit the first ultrasonic waves having higher sound pressure over the entire region of the plurality of nozzles N.

According to the second embodiment described above, the first channels CHA and the second channels CHB are alternately arranged in the Y direction. Thus, it is possible to transmit the first ultrasonic waves having higher sound pressure over the entire region of the plurality of nozzles N.

### C. Third Embodiment

An ultrasonic device 80 of a third embodiment is different from the ultrasonic device 80 of the first embodiment in the arrangement mode of the first ultrasonic vibrators 8A and the second ultrasonic vibrators 8B. The differences from the first embodiment will be described, and the other description will be omitted. The same configurations and processing steps as those of the first embodiment are denoted by the same signs, and the detailed description thereof will be omitted as appropriate.

FIG. 15 is a plan view showing an overall configuration of the ultrasonic device 80 of the present embodiment. The ultrasonic device 80 of the first embodiment has a configuration in which the channels CH as groups of independently controllable ultrasonic vibrators 8 are arranged only in one direction. In contrast, channels CH of the present embodiment are arranged in a matrix. In the present embodiment, the ultrasonic device 80 does not include the acoustic lens 73.

As shown in FIG. 15, the ultrasonic device 80 of the present embodiment includes a plurality of ultrasonic vibrator arrays DC in which first ultrasonic vibrators 8A and second ultrasonic vibrators 8B are alternately arranged in the Y direction as the first direction. The ultrasonic vibrator arrays DC are arranged in the X direction as the second direction intersecting the first direction and not intersecting the injection surface 62a at a right angle.

In the present embodiment, one channel CH includes one ultrasonic vibrator 8. In the first embodiment, the plurality of second electrodes 84 are electrically coupled to each other to form the channel CH. In contrast, the second electrodes 84 of the present embodiment are not electrically coupled to each other, and are configured to be controllable independently of each other.

The controller 90 focuses the ultrasonic waves in the target range Atg by synchronizing the emission timing of the ultrasonic vibrators 8 arranged in the first direction with the emission timing of the ultrasonic vibrators 8 arranged in the second direction.

Typically, the controller 90 performs control such that the emission timings of the ultrasonic vibrators 8 at the same distance from the target range Atg are the same. Accordingly, the target range Atg can be set at a desired position not only in the direction in which the nozzles N are arranged on the injection surface 62a but also in the direction intersecting the direction in which the nozzles N are arranged.

According to the third embodiment described above, the plurality of ultrasonic vibrator arrays DC in which the first ultrasonic vibrators 8A and the second ultrasonic vibrators 8B are alternately arranged are arranged in the X direction. The first ultrasonic vibrators 8A and the second ultrasonic vibrators 8B can be controlled independently. Accordingly, the ultrasonic waves can be focused not only in the Y direction but also at any position in the X direction.

### D. Fourth Embodiment

An ultrasonic device 80 of a fourth embodiment is different in structure from the ultrasonic device 80 of the first embodiment. The differences from the first embodiment will be described, and the other description will be omitted. The same configurations and processing steps as those of the first embodiment are denoted by the same signs, and the detailed description thereof will be omitted as appropriate.

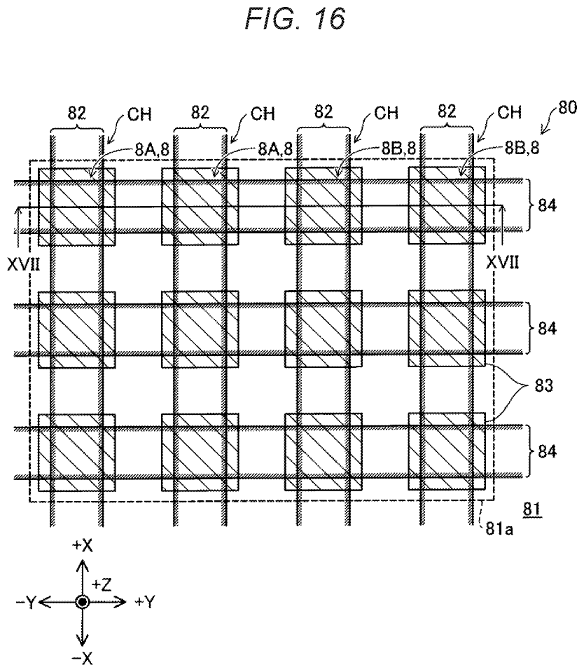

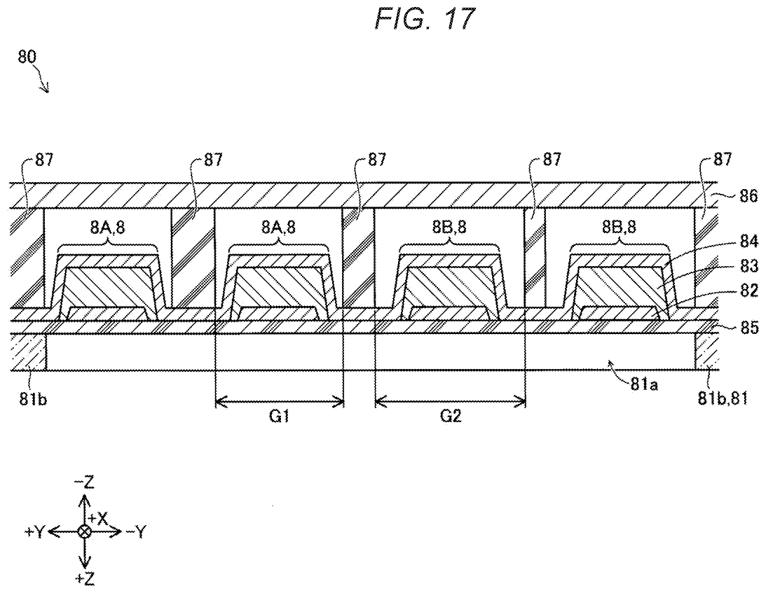

FIG. 16 is a plan view showing a detailed configuration of the ultrasonic device 80 of the fourth embodiment. FIG. 17 is a cross-sectional view taken along line XVII-XVII in FIG. 16. The opening portion 81a formed in the first substrate 81 of the first embodiment is formed so as to include one ultrasonic vibrator 8 with respect to the Y direction and include three ultrasonic vibrators 8 with respect to the X direction. In contrast, as shown in FIG. 16, an opening portion 81a of the present embodiment is formed so as to include four ultrasonic vibrators 8 with respect to the Y direction and three ultrasonic vibrators 8 with respect to the X direction.

As shown in FIG. 17, a column portion 87 is formed between two ultrasonic vibrators 8 adjacent to each other in the Y direction. A first gap G1 which is a distance between two column portions 87 adjacent to each other in the Y direction with a first ultrasonic vibrator 8A in between is smaller than a second gap G2 which is a distance between two column portions 87 adjacent to each other in the Y direction with a second ultrasonic vibrator 8B in between. Accordingly, the first ultrasonic vibrator 8A can transmit ultrasonic waves having a frequency higher than the frequency of the ultrasonic waves transmitted from the second ultrasonic vibrator 8B.

In the first embodiment, the wall portion 81b is used as the fixed end of the vibration of the diaphragm 85 with respect to the Y direction. In this regard, as in the present embodiment, the column portion 87 may be used as a fixed end of the vibration of the diaphragm 85. When the opening portion 81a is formed by etching in a semiconductor manufacturing process, when the opening area of the opening 81a is small, the control of the etching may be difficult. In this regard, according to the present embodiment, the opening area of the opening portion 81a is made larger, and thus the opening 81a can be formed with high accuracy by etching. In this case, the fixed end of the vibration may be formed using the column portion 87. Furthermore, in the present embodiment, since the permanent resist is used for the column portion 87, the column portion 87 that f functions as a fixed end of vibration can be formed more easily.

### E. Other Embodiments

(E1) In the first embodiment described above, the controller 90 performs control such that the first ultrasonic waves are focused in the target range Atg. As another embodiment, the controller 90 may not perform control such that the first ultrasonic waves are focused in the target range Atg. Specifically, for example, the controller 90 may perform control to transmit the first ultrasonic waves from the plurality of first ultrasonic vibrators 8A without shifting the emission timing of the first ultrasonic waves. Even when the first ultrasonic waves are not focused in the target range Atg, high pressure can be instantaneously generated by transmitting the second ultrasonic waves after the first ultrasonic waves are transmitted, so that the removal capability can be improved.

(E2) In the first embodiment described above, the waveform of the burst signal Sigd in the first period TD1 is the sine wave, but the waveform is not limited to the sine wave. The waveform of the burst signal Sigd in the first period TD1 may be, for example, a rectangular wave.

(E3) In the first embodiment described above, in order to focus the ultrasonic waves in the target range Atg, the plurality of ultrasonic vibrators 8 are controlled such that the emission timing is shifted according to the first direction. As another embodiment, for example, at least two ultrasonic vibrators 8 may be controlled such that the emission timings of the at least two ultrasonic vibrators 8 of the plurality of ultrasonic vibrators 8 are shifted from each other. Specifically, for example, the same burst signal Sigd may be input to two adjacent ultrasonic vibrators 8. At least two ultrasonic vibrators 8 among the plurality of ultrasonic vibrators 8 are controlled so that the emission timings of the burst waves are shifted from each other, and thus the ultrasonic waves can be focused in the target range Atg.

(E4) In the first embodiment described above, the controller 90 specifies the abnormal nozzle and acquires a range including the specified abnormal nozzle as the deposition range. In the first embodiment, the residual vibration after injection of the ink is used to specify the abnormal nozzle. As another embodiment of specifying the abnormal nozzle, the controller 90 may specify the abnormal nozzle using a captured image obtained by imaging a printed matter with a camera. For example, when the deposition position of the deposits DE can be specified using the captured image of the printed matter, the controller 90 may acquire the deposition position as the deposition range instead of the abnormal nozzle. Alternatively, the controller 90 may acquire the deposition position of the deposits DE specified using the captured image obtained by imaging the nozzle plate 62 with the camera as the deposition range. For example, when a position where the deposits DE are likely to be deposited is statistically obtained depending on the position of the nozzle plate 62, the controller 90 may acquire the position as the deposition range. Specifically, for example, the deposition range may be stored in advance in a storage circuit of the controller 90, and the controller 90 may acquire the deposition range by referring to the storage circuit.

(E5) In the first embodiment described above, in step S18, the controller 90 sets the range including the nozzle N as the target range Atg as illustrated in FIG. 9. When there is an injection abnormality, the deposits DE are not necessarily deposited inside of the nozzle N of the abnormal nozzle. For example, the deposits DE may be deposited around the abnormal nozzle. Therefore, as another embodiment, step S20 and step S22 with the varied target ranges Atg may be performed at a plurality of times so that the ultrasonic waves are focused in the range including the nozzle N and the nozzle periphery not including the nozzle N.

(E6) In the first embodiment described above, the liquid LQ injected from the nozzle N is stored in the recess 71a of the cap 71. As another embodiment, the recess 71a may include a supply flow path to which the liquid LQ is supplied, and the liquid LQ may be supplied from the supply flow path. In the first embodiment, the cleaning device 70 includes the acoustic lens 73, but may not include the acoustic lens 73. Even when the acoustic lens 73 is not provided, the ultrasonic waves can be focused at least in the arrangement direction of the channels CH. In the fourth embodiment, the cleaning device 70 does not include the acoustic lens 73, but may include the acoustic lens 73.

(E7) In the first embodiment described above, the frequency of the first ultrasonic waves is from about 1 MHz to about 10 MHz. The frequency of the second ultrasonic waves is about 100 kHz or more and less than 1 MHz. As another embodiment, the frequency of the first ultrasonic waves may be from about 1 MHz to about 10 MHz, and the frequency of the second ultrasonic waves may be lower than the frequency of the first ultrasonic waves. The lower limit of the frequency of the second ultrasonic waves is, for example, about 10 KHz.

(E8) In the second embodiment described above, the first ultrasonic vibrators 8A and the second ultrasonic vibrators 8B are alternately arranged in the Y direction. As another embodiment, the first ultrasonic vibrators 8A and the second ultrasonic vibrators 8B may be alternately arranged every several vibrators in the Y direction. In the fourth embodiment described above, the plurality of ultrasonic vibrator arrays DC are arranged such that the positions of the ultrasonic vibrators 8 in the Y direction coincide with one another. As another embodiment, the ultrasonic vibrators 8 may be arranged in a so-called staggered arrangement such that the positions of the ultrasonic vibrators in the Y direction are shifted from one another. As another embodiment, the first ultrasonic vibrators 8A and the second ultrasonic vibrators 8B may be alternately arranged in the X direction.

(E9) In the first embodiment described above, the electrodes in the lower layer than the piezoelectric elements 83 are individual electrodes, and the electrode in the upper layer than the piezoelectric elements 83 is the common electrode. As another embodiment, the electrode in the lower layer than the piezoelectric elements 83 may be a common electrode, and the electrodes in the upper layer than the piezoelectric elements 83 may be individual electrodes.

### F. Other Configurations

The present disclosure is not limited to the embodiments described above, and can be implemented in various forms without departing from the scope of the present disclosure. For example, the present disclosure may also be implemented in the following configurations. The technical features in the embodiments described above corresponding to the technical features in the configurations described below can be replaced or combined as appropriate in order to solve a part or all of the problems of the present disclosure, or to achieve a part or all of the effects of the present disclosure. Also, any of the technical features can be deleted as appropriate unless described as essential in the present specification.

(1) According to a first aspect of the present disclosure, there is provided a cleaning device for cleaning a nozzle plate having an injection surface and a plurality of nozzles for injecting a liquid formed therein. The cleaning device includes a cap that is disposed to face the injection surface, has a recess, and is configured to store the liquid in a space surrounded by the recess and the injection surface, an ultrasonic device that is provided in the cap and transmits ultrasonic waves toward the injection surface, and a controller, wherein the ultrasonic device includes a plurality of first ultrasonic vibrators that transmit first ultrasonic waves as the ultrasonic waves having a first frequency, and a plurality of second ultrasonic vibrators that transmit second ultrasonic waves as the ultrasonic waves having a second frequency lower than the first frequency, and the controller causes the ultrasonic device to transmit the first ultrasonic waves and then causes the ultrasonic device to transmit the second ultrasonic waves with the liquid stored in the space. According to the configuration, a large number of bubbles are generated in the liquid by cavitation generated by the emission of the first ultrasonic waves in a state where the liquid is stored in the space surrounded by the recess and the injection surface. Thereafter, the second ultrasonic waves are transmitted, so that a large number of bubbles collapse and high pressure is generated. As described above, since high pressure can be efficiently generated, it is possible to improve the removal capability for deposits.

(2) In the aspect described above, the controller may set a part of a range including the injection surface and the plurality of nozzles as a target range, and when causing the ultrasonic device to transmit the first ultrasonic waves, controls the ultrasonic device to focus the first ultrasonic waves in the target range. According to the configuration, the ultrasonic waves can be selectively focused in the target range.

(3) In the aspect described above, the controller may specify an abnormal nozzle which is a nozzle having an injection abnormality among the plurality of nozzles, and sets a range including at least one of the abnormal nozzle and a nozzle periphery which is a range on the injection surface surrounding the abnormal nozzle as the target range. According to the configuration, the ultrasonic waves can be selectively focused on the deposits that cause the injection abnormality.

(4) In the aspect described above, the controller may input a burst signal in which a frequency in a signal transmission period is the first frequency to the plurality of first ultrasonic vibrators, when the burst signal is input, each of the plurality of first ultrasonic vibrators may transmit burst waves in which a frequency of the first ultrasonic waves in an ultrasonic wave transmission period is the first frequency, and in order to focus the first ultrasonic waves in the target range, the controller may control the first ultrasonic vibrator to which the burst signal is input among the plurality of first ultrasonic vibrators to shift an emission timing when transmitting the burst wave according to a distance between the target range and each of the first ultrasonic vibrators.

(5) In the aspect described above, the plurality of first ultrasonic vibrators and the plurality of second ultrasonic vibrators may be arranged in a first direction.

(6) In the aspect described above, the first ultrasonic vibrators and the second ultrasonic vibrators may be alternately arranged in the first direction. According to the configuration, it is possible to transmit ultrasonic waves having higher sound pressure over the entire region of the nozzle plate.

(7) In the aspect described above, a plurality of ultrasonic vibrator arrays in which the first ultrasonic vibrators and the second ultrasonic vibrators are alternately arranged in the first direction may be provided, and the plurality of ultrasonic vibrator arrays may be arranged in a second direction intersecting the first direction and not intersecting the injection surface at a right angle.

(8) In the aspect described above, a diaphragm, a plurality of piezoelectric elements formed on the diaphragm, a substrate disposed to face the diaphragm, and a pair of fixing portions corresponding to each of the plurality of piezoelectric elements and fixing the diaphragm to the substrate may be provided, and the plurality of first ultrasonic vibrators and the plurality of second ultrasonic vibrators may be respectively arranged in a first direction, each of the piezoelectric elements may be disposed between the pair of fixing portions when the diaphragm is viewed in a direction perpendicular to the diaphragm, the plurality of piezoelectric elements may include a first piezoelectric element corresponding to each of the plurality of first ultrasonic vibrators and a second piezoelectric element corresponding to each of the plurality of second ultrasonic vibrators, and a gap in the first direction between the pair of fixing portions corresponding to the first piezoelectric element may be smaller than a gap in the first direction between the pair of fixing portions corresponding to the second piezoelectric element. According to the configuration, by adjusting the gap between the pair of fixing portions, the first ultrasonic vibrator and the second ultrasonic vibrator having different resonance frequencies from each other can be easily fabricated on the same substrate.

The present disclosure can be implemented in other various aspects than the cleaning device. For example, the present disclosure can be implemented in aspects of a cleaning method for a nozzle plate, a computer program for implementing the cleaning method, a non-transitory recording medium in which the computer program is recorded, or the like.

What is claimed is:

1. A cleaning device for cleaning a nozzle plate that has an injection surface and at least one nozzle for injecting a liquid formed therein, the cleaning device comprising:
a cap that is disposed to face the injection surface, has a recess, and is configured to store the liquid in a space surrounded by the recess and the injection surface;
an ultrasonic device that is provided in the cap and transmits ultrasonic waves toward the injection surface; and
a controller, wherein
the ultrasonic device includes a plurality of first ultrasonic vibrators that transmit first ultrasonic waves as the ultrasonic waves having a first frequency, and a plurality of second ultrasonic vibrators that transmit second ultrasonic waves as the ultrasonic waves having a second frequency lower than the first frequency, and
the controller causes the ultrasonic device to transmit the first ultrasonic waves and then causes the ultrasonic device to transmit the second ultrasonic waves with the liquid stored in the space.

2. The cleaning device according to claim 1, wherein
the controller sets a part of a range including the injection surface and the at least one nozzles as a target range, and when causing the ultrasonic device to transmit the first ultrasonic waves, controls the ultrasonic device to focus the first ultrasonic waves in the target range.

3. The cleaning device according to claim 2, wherein
the controller specifies an abnormal nozzle which is a nozzle having an injection abnormality among the at least one nozzles, and sets a range including at least one of the abnormal nozzle and a nozzle periphery which is a range on the injection surface surrounding the abnormal nozzle as the target range.

4. The cleaning device according to claim 3, wherein
the controller outputs a burst signal in which a frequency in a signal 1 transmission period is the first frequency to the plurality of first ultrasonic vibrators,
when the burst signal is input, each of the plurality of first ultrasonic vibrators transmits burst waves in which a frequency of the first ultrasonic waves in an ultrasonic wave transmission period is the first frequency, and
the controller controls the first ultrasonic vibrator to which the burst signal is input among the plurality of first ultrasonic vibrators to shift an emission timing when transmitting the burst wave according to a distance between the target range and each of the first ultrasonic vibrators.

5. The cleaning device according to claim 1, wherein
the plurality of first ultrasonic vibrators and the plurality of second ultrasonic vibrators are respectively arranged in a first direction.

6. The cleaning device according to claim 5, wherein
each of the first ultrasonic vibrators and each of the second ultrasonic vibrators are alternately arranged in the first direction.

7. The cleaning device according to claim 5, further comprising a plurality of ultrasonic vibrator arrays in which each of the first ultrasonic vibrators and each of the second ultrasonic vibrators are alternately arranged in the first direction, wherein
the plurality of ultrasonic vibrator arrays is arranged in a second direction intersecting the first direction and not intersecting the injection surface at a right angle.

8. The cleaning device according to claim 1, further comprising:
a diaphragm;
a plurality of piezoelectric elements formed on the diaphragm;
a substrate disposed to face the diaphragm; and
a pair of walls corresponding to each of the plurality of piezoelectric elements and fixing the diaphragm to the substrate, wherein
the plurality of first ultrasonic vibrators and the plurality of second ultrasonic vibrators are respectively arranged in a first direction,
each of the piezoelectric elements is disposed between the pair of walls when the diaphragm is viewed in a direction perpendicular to the diaphragm,
the plurality of piezoelectric elements includes a first piezoelectric element corresponding to each of the plurality of first ultrasonic vibrators and a second piezoelectric element corresponding to each of the plurality of second ultrasonic vibrators, and
a gap in the first direction between the pair of walls corresponding to the first piezoelectric element is smaller than a gap in the first direction between the pair of walls corresponding to the second piezoelectric element.
